(19) United States
(12) Patent Application Publication
(10) Pub. No.: US 2012/0033085 A1
(43) Pub. Date: Feb. 9, 2012

(54) Color Uniformity Correction System and Method of Correcting Color Uniformity

(75) Inventor: Gokalp Bayramoglu, Xiamen (CN)

(73) Assignee: TPK HOLDING CO., LTD

(21) Appl. No.: 13/009,850

(22) Filed: Jan. 20, 2011

Related U.S. Application Data
(63) Continuation-in-part of application No. 11/593,074, filed on Nov. 6, 2006, now abandoned.

(51) Int. Cl. H04N 17/02

(52) U.S. Cl. 348/177; 348/E17.006

(57) ABSTRACT

The present invention discloses a color uniformity correction system for correcting color uniformity problems that exist within today's display devices. The color uniformity correction system includes a capture unit for detecting a video signal applied to a display unit and generate corresponding first color values; a storage for storing the color calibration values of a plurality of pixel locations on the display unit; a converter unit for adding the color calibration values to the first color values to generate a plurality of second color values of the video signal and a driver unit for receiving and sending the second color values to the display unit.

### CROSS-REFERENCE TO RELATED APPLICATIONS

This application is a CIP of Ser. No. 11/593,074, filed Nov. 6, 2006 by the present inventor, which is incorporated herein by reference.

### BACKGROUND OF THE INVENTION

1. Technical Field

The present invention relates to a color uniformity correction system for correcting color uniformity problems present in today's display devices.

2. Description of the Related Art

Color images can be captured and converted into a video signal, which can be transmitted to a display system, such as a television. The display system typically processes the input video signal and transmits the processed video signal to a display device, which reproduces the luminance and color of the images onto its display screen for a viewer. Typical display devices include liquid-crystal displays (LCD), cathode-ray tubes (CRT), and plasma display panels (PDP). Each display device employs complex mechanisms that take the video signal and reproduce the luminance and color properties of the image.

An image generated by a color visual display device is defined by red, green and blue image components. These image components are generated by red, green and blue video signals. The color balance, sometimes referred to as the color point, of the display device is a measure of the relative intensities of the components when the video signals are arranged to produce a standard image in the form of a white block. The color point is generally specified as the coordinates corresponding to a white block on a chromaticity reference chart. In a color display device, the color point is determined by the relative gains of the red, green, and blue video channels of the device.

However, during the reproduction process of the video signal, the color of the image displayed on the display screen of the display device often changes. That is to say, during the reproduction process, the same input color signal on different spots on the display screen may change and the output color signal which is displayed on the display screen may be different from the input color signal. As a result, the same color may look in different shades and colors, and the colors of the image will not be uniform. Therefore, it is important to have a color correction system in the display device to correct color uniformity. Normally, the conventional color correction system is installed in the display device, and people can selectively adjust the color of image displayed by using an input button setting on the display device. The conventional color correction system is hand-operated. Users adjust the image color according to their needs.

The main problem with the conventional color correction systems is that they do not provide good color uniformity. Furthermore, the calibration process cannot cover the whole screen of the display device. Therefore good color uniformity cannot be achieved by the conventional color correction systems. The conventional color correction systems are based on the calibration performed by the user. Another problem in the conventional color correction systems is that they require user interference. It is not convenient for end user to perform screen calibration. Besides, the conventional color uniformity system can only cover certain points on the screen. The rest of the screen of the display device is interpolated.

Therefore, a new color uniformity correction system which can automatically adjust into a good color uniformity of a display device is needed to overcome said problems.

### BRIEF SUMMARY OF THE INVENTION

In view of the foregoing disadvantages inherent in the known types of color correction system now present in the prior art, the present invention provides a new color uniformity correction system construction wherein the same can be utilized for correcting color uniformity problems that exist within today's display devices.

The present invention provides for a new color uniformity correction system that can make a display device having good color uniformity.

Another object is to provide a color uniformity correction system that will correct the color uniformity problem in display devices so that same color on different spots on the screen of the display devices will not be in different shades and colors.

Further object of the present invention is to provide a new color uniformity correction system which can automatically adjust the color uniformity of a display device.

Further object of the present invention is to provide a method of correcting the color uniformity of a display device.

Further object of the present invention is to provide a color uniformity characterizations system.

Further object of the present invention is to provide a method of characterizing a display device.

Further object is to provide a color correction system that will correct the color uniformity of screens such that production yield of CRT, LCD, Plasma and any other screen manufacturers will go up and as a result, the production cost of the screens will be reduced.

Further object is to provide a color uniformity system that will correct the color uniformity issue on the screen of display devices so that people can use these devices for color sensitive applications such as ecommerce applications.

In general, the present invention discloses a color uniformity correction system including a capture unit for detecting a video signal applied to a display unit and generating corresponding first color values; a storage for storing color calibration values of a plurality of pixel locations on the display unit; a converter unit for adding the color calibration values into the first color values to generate a plurality of second color values of the video signal and a driver unit for sending the second color values to a display unit.

Accordingly, the capture unit has a plurality of probes to detect and measure the video signal at a plurality of pixel locations.

Accordingly, the color values are tri-stimulus values.

Accordingly, the color correction system further includes a display unit for displaying the video signal.

Accordingly, the color correction system further includes a host computer for sending the video signal to the display unit.

In another aspect, the invention also discloses a method of correcting color uniformity of a display device including steps of: sending a video signal to the display device; capturing the video signal by a capture unit; adding a calibrating signal to the video signal for generating a new video signal.

Accordingly, the capture unit has a plurality of probes to detect and measure the video signal at a plurality of pixel locations.

The present invention further discloses a color uniformity characterizations system including a host computer for sending color video signals to a display device; a measuring unit for measuring the color values of a video signal displayed on the display device at a plurality of pixel locations; a processor unit connected to the measuring unit for receiving and processing the color values and generating a plurality of calibration values; and a storage unit for storing the calibration values.

Accordingly, the processor unit further includes a calculating unit for calculating the value differences between color values applied to the display unit and color values measured by the measuring unit to generate the calibration values.

Accordingly, the measuring unit has a plurality of probes for detecting and measuring a video signal on the display characterization at a plurality of pixel locations.

Accordingly, the measuring unit is a robot arm with a single probe that moves on the surface of the display under characterization for detecting and measuring the color values of the video signal at a plurality of pixel locations on the display device.

Accordingly, the color values and calibration values are tri-stimulus values.

Accordingly, the processor unit includes a microcontroller with an embedded software.

Accordingly, the host computer is a stand along computer.

Accordingly, the host computer is a handheld device.

Accordingly, the processor unit is embedded in the handheld device.

The present invention further discloses a method of characterizing a display device including steps of: displaying a video signal comprising a known color value for each pixel location on the display device covering a plurality of pixel locations; measuring the color values of the plurality of pixel locations; calculating the difference of value between the video signal with known color value and the color value for each pixel location; and storing the difference of value in a storage unit.

Accordingly, the color values are tri-stimulus values.

These and other features of the present disclosure are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a schematic view showing the color uniformity correction system according to the present invention.

FIG. 2 is a schematic view of the capture unit and the display unit of the present invention shown in FIG. 1.

FIG. 3 is a top view of the capture unit of the present invention shown in FIG. 2

FIG. 4 is a flow chart of implementation steps for correcting color uniformity of a display device according to the present invention shown in FIG. 1.

FIG. 5 is a schematic view of a color uniformity characterizations system in accordance with the present invention.

FIG. 6 is a flow chart of implementation steps for characterizing a display device according to the present invention shown in FIG. 5.

FIG. 7 is a schematic view of the measuring unit shown in FIG. 5.

FIG. 8 is a flow chart of characterization of the present invention.

FIG. 9 is a schematic view showing the color uniformity correction of a display device of the present invention.

### DETAILED DESCRIPTION

Now referring more specifically to the figures, identical parts are designated by the same reference numerals throughout. In accordance with the usual meaning of “a” and “the” in patents, reference, for example to “a” unit or “the” unit is inclusive of one or more units. The section headings used herein are for organizational purposes only, and are not to be construed as limiting the subject matter described.

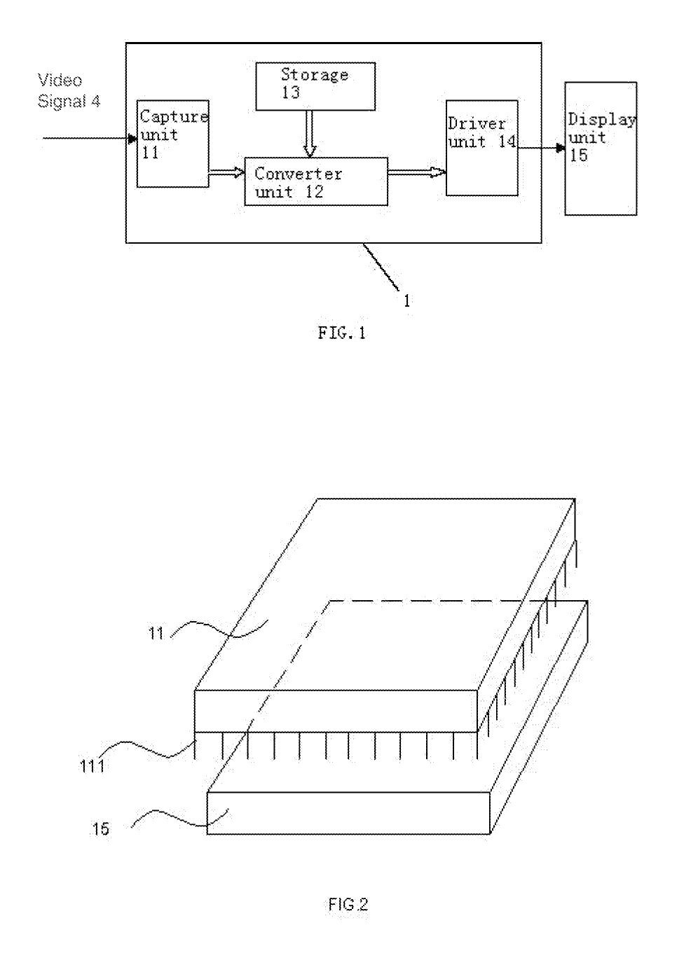

Referring to FIG. 1, a plan view of a color uniformity correction system of the present invention is shown. The color uniformity correction system 1 includes a capture unit 11 for detecting a video signal applied to a display unit 15 and generating corresponding first color values, a storage 13 for storing the color calibration values of a plurality of pixel locations on the display unit, a converter unit 12 for adding the color calibration values to the first color values to generate a plurality of second color values of the video signal and a driver unit 14 for receiving and sending the second color values to the display unit 15.

Referring to FIG. 2 and FIG. 3, FIG. 2 shows a schematic view of the capture unit and the display unit of the present invention. The capture unit 11 having a plurality of probes 111 on it is placed on the display unit 15 and captures the color information on the display unit 15. The capture unit 11 detects and measures the video signal coming from the probes 111 at a plurality of pixel locations of the display unit 15. The capture unit 11 can be any circuit that measures the color of the signal. FIG. 3 is a top view of the capture unit 11 of the present invention shown in FIG. 2. The capture unit 11 has a plurality of probes 111 and is placed on the display unit 15 to measure the color at many different points at the same or approximated time. They are made of light sensitive and color sensitive devices and their main function is to detect the signal and to communicate with Measuring Assembly. The probes 111 can be built using any light detecting material. Its function is to measure the color signal. The capture unit 11 should have enough probes 111 to cover the whole display area of the display unit 15.

The capture unit 11 detects the video signal on the display unit 15 and generates corresponding first color values, then sends the first color values to the converter unit 12. The capture unit 11 performs the measurement on the video. Tri-stimulus values, which are RGB (Red, Green, Blue) values, of the video signal are measured. These Tri-stimulus values are sent to the converter unit 12. The converter unit 12 receives the tri-stimulus values, and adds the color calibration values of a plurality of pixel locations on the display, where the color calibration values have been stored in the storage 13, into the first color values to calibrate the first color values displayed on the display unit 15, and then generates a set of second color values of the video signal. The color calibration values are also tri-stimulus values. The driver unit 14 receives and sends the second color values to the display unit 15 to display. The display unit 15 receives the second color values and displays corresponding video signals. The detection of the color can be accomplished by using any color detection technique. The probes 111 are specially designed to detect color from a small area on the display units 15.

The storage 13 where the color calibration values are stored can either be volatile or non-volatile memory. The color correction of the live display signal is performed by using the stored color calibration values. This operation can either be performed in the software or by the controller in the display unit 15. Hardware unit that resides in the display unit 15 performs color calculations if they are not done in the software in converter unit 12. Controller resides in the display device and performs color shifting calculations if they are not performed in the software. Controller can be built any micro controller that is capable of performing color shifting. The color correction system 1 further includes a host computer for sending the video signal to the display unit 15. Software resides on the host computer and uses the stored color calibration values to correct the color values which are applied to display unit 15. Software can be written in any programming language. It can be at application level or driver level on the host computer. Software can perform the color shifting.

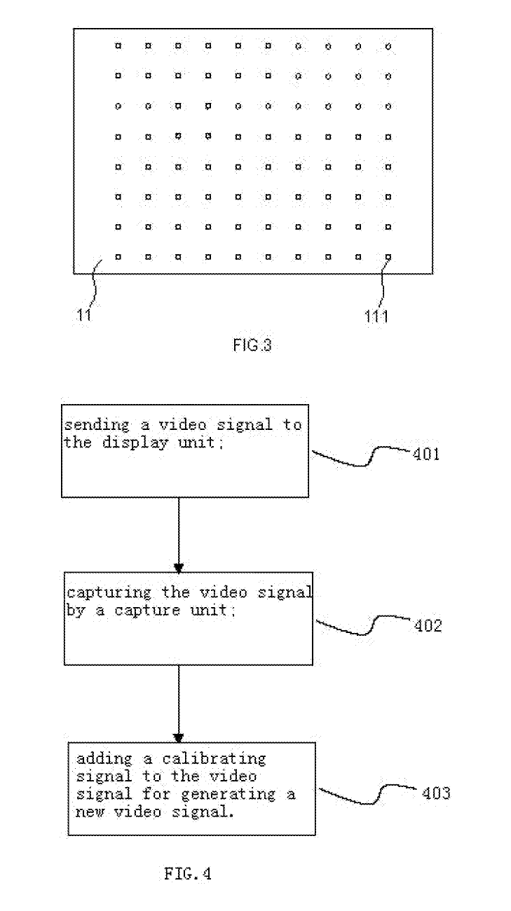

In this section, a flow chart of implementation steps for correcting color uniformity of a display device according to the present invention is shown in FIG. 4. The method includes the following steps. In step 401, a host computer sends a video signal to the display unit 15 of a display device. In step 402, the capture unit 11 captures the video signal and sends the captured video signal to the converter unit 12. In step 403, the converter unit 12 adds a calibrating signal, which is stored in the storage unit 13, into the video signal for generating a new video signal to display. After the above described steps are implemented, the color uniformity of the display device is corrected.

The apparatus for generating the calibration values of the above mentioned calibrating signal to characterize the color uniformity of the display device and the method of characterizing the display device will be described in the following paragraphs. Referring to FIG. 5, a schematic view of a color uniformity characterizations system in accordance with the present invention is shown. The color uniformity characterizations system 5 includes a host computer 51 for sending color video signals to a display device, a measuring unit 52 for measuring the color values of a video signal displayed on the display device at a plurality of pixel locations, a processor unit 53 connected to the measuring unit 52 for receiving and processing the color values and generating a plurality of calibration values, and a storage unit 54 for storing the calibration values. The color values and calibration values are tri-stimulus values.

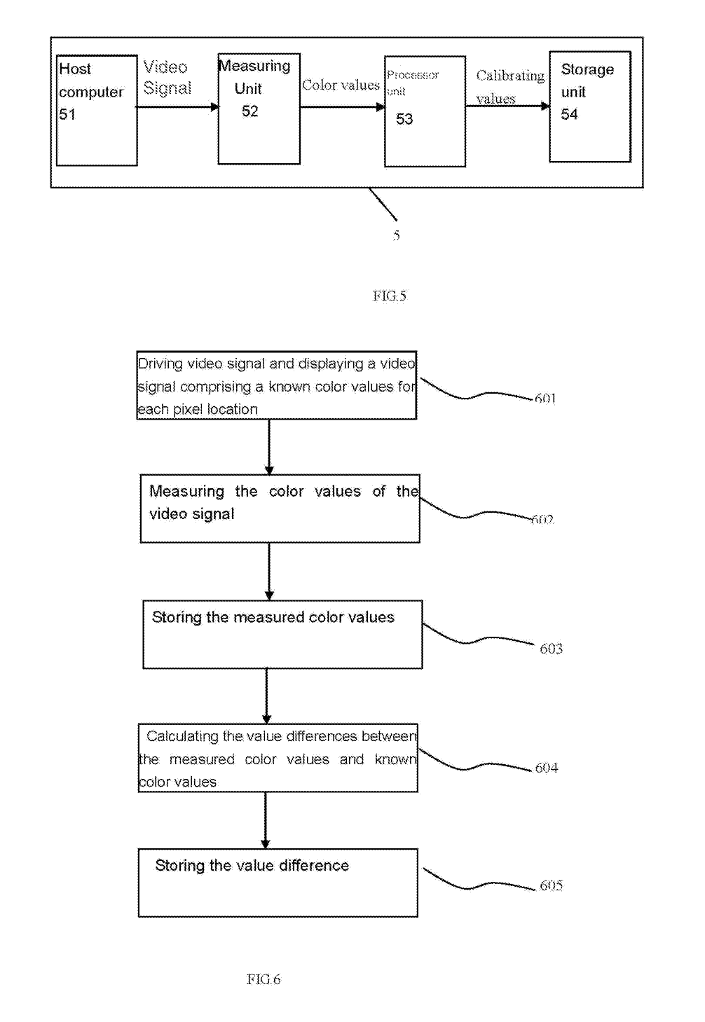

The processor unit 53 further includes a calculating unit for calculating the value differences between color values applied to the display device and color values measured by the measuring unit to generate the calibration values. The measuring unit 52 has a plurality of probes for detecting and measuring a video signal on the display device which has been characterized at a plurality of pixel locations, which characterization process is shown in FIG. 6. In other situations, the measuring unit 52 is a robot arm with a single probe that moves on the surface of the display device under characterization for detecting and measuring the color values of the video signal at a plurality of pixel locations on the display device.

The processor unit 53 uses the color information from the measuring unit 52 and also communicates with the host computer 51 where the display device is driven. The processor unit 53 can be designed by using any microcontroller that is capable of communicating with the computer 51. The processor unit 53 includes a microcontroller with embedded software. The processor unit 53 communicates with the software on the host computer 51. Here it is assumed that host computer 51 and display device are two separate units and can communicate via standard communication lines, such as USB or serial lines. Alternatively, a handheld unit has both the display and the host on the unit therefore a special communication line can be used in that case. The processor unit 53 stores the color information in a memory.

In this section, a flow chart of implementation steps for characterizing a display device according to the present invention is shown in FIG. 6. A method of characterizing a display device includes the following steps. In step 601, the host computer 51 drives a video signal comprising a known color value for each pixel location on the display device covering a plurality of pixel locations to display. In step 602, the measuring unit 52 measures the color values of the plurality of pixel locations. In step 603, memory in the processor unit 53 stores the color values measured in step 602. In step 604, the processor unit 53 calculates the difference of value between the video signal with known color value and the color value for each pixel location. In step 604, the storage unit 54 stores the difference of value. After the above described steps are implemented, the display device is characterized.

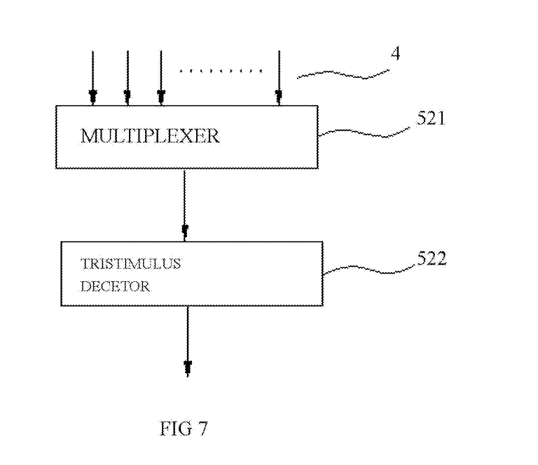

FIG. 7 is a schematic view of the measuring unit shown in FIG. 5. FIG. 7 shows the details of the measuring unit 52. When many probes are used, a multiplexer 521 is utilized to select the current probe so that the signal from the location under test can be applied to the tri-stimulus detector 522. The output of the tri-stimulus detector 522 is stored in a memory to be used during the operation.

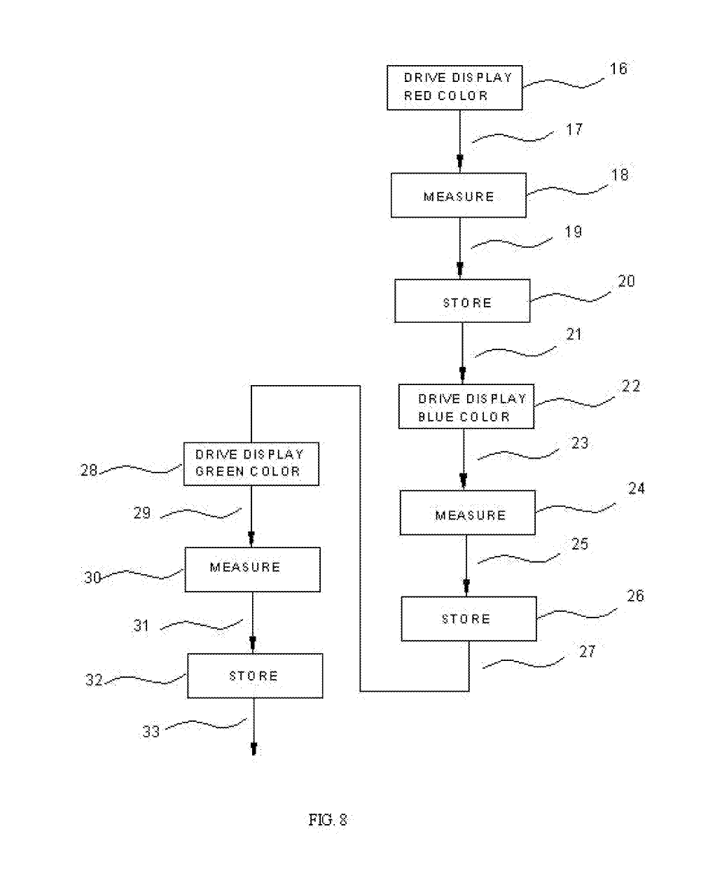

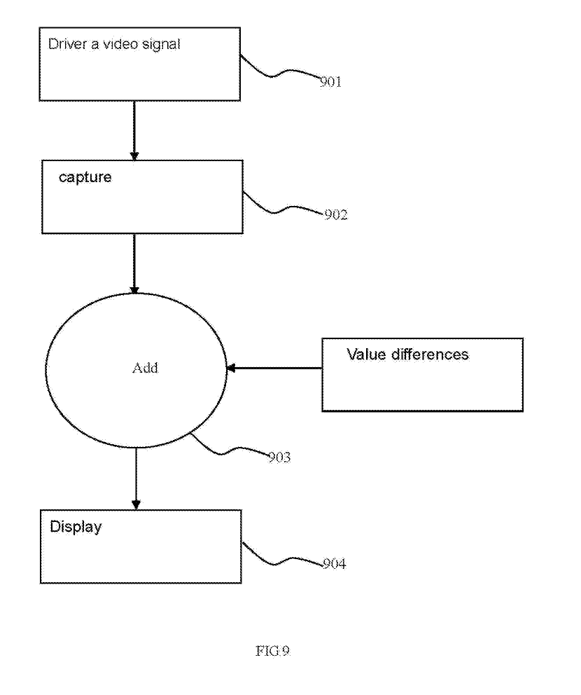

FIG. 8 is a flow chart of characterization of the present invention. The algorithm that is used to detect the color values on the different parts of the screen is shown in FIG. 8. Here the display device is driven by the red color in step 16. The color of the screen of the display device is measured in step 18 and stored in the memory in step 20. Then the screen of the display device is driven by the blue color in step 22 and the output of the screen is measured in step 24 and stored in the memory in step 26. The screen of the display device is driven by the green color in step 28 and the output of the screen is measured in step 30. The measured values are stored in step 32.

FIG. 9 is a schematic view showing the color uniformity correction processes of a display device of the present invention. After screen of the display device is characterized, all the color values are stored in the memory. In step 901, the video signal comes from the host computer. This is the video signal that is sent from the host computer 51 to the display device. In step 902, the video signal is captured, and the color values of the video signal are compared with the measured values shown in FIG. 8 and the value difference are stored. If the stored value difference is zero, the captured video signal does not change. In the step 903, the stored value differences are added into the video signal color value to compensate the difference on the display. Once the new color value is calculated, the display device is driven by the new signal 40 in step 904. This new signal is the one that compensates for the different location on the screen. By this way, the color will look the same no matter where it is displayed on the screen.

The above mentioned description is given by way of example, and not limitation. Given the above disclosure, one skilled in the art could devise variations that are within the scope and spirit of the invention disclosed herein, including configurations and ways of the recessed portions and materials and/or designs of the attaching structures. Furthermore, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A color uniformity correction system comprising: a capture unit for detecting a video signal applied to a display unit and generating corresponding first color values; a storage for storing color calibration values of a plurality of pixel locations on the display unit; a converter unit for adding the color calibration values into the first color values to generate a plurality of second color values of the video signal and a driver unit for receiving and sending the second color values to the display unit.

2. The color uniformity correction system in accordance with claim 1, wherein the capture unit comprises a plurality of probes to detect and measure the video signal at a plurality of pixel locations.

3. The color uniformity correction system in accordance with claim 1, wherein the color values are tri-stimulus values.

4. The color uniformity correction system in accordance with claim 1, further comprising a display unit for displaying the video signal.

5. The color uniformity correction system in accordance with claim 1, further comprising a host computer for sending the video signal to the display unit.

6. A method of correcting color uniformity of a display device comprising steps of: sending a video signal to a display device; capturing the video signal by a capture unit; adding a calibrating signal into the video signal for generating a new video signal.

7. The method of correcting color uniformity of a display device in accordance with claim 6, wherein the capture unit comprises a plurality of probes to detect and measure the video signal at a plurality of pixel locations of the display device.

8. A color uniformity characterizations system comprising: a host computer for sending color video signals to a display device; a measuring unit for measuring color values of a video signal displayed on the display device at a plurality of pixel locations; a processor unit connected to the measuring unit for receiving and processing the color values and generating a plurality of calibration values; and a storage unit for storing the calibration values.

9. The color uniformity characterizations system in accordance with claim 8, wherein the processor unit further comprises a calculating unit for calculating value differences between color values applied to the display unit and the color values measured by the measuring unit to generate the calibration values.

10. The color uniformity characterizations system in accordance with claim 8, wherein the measuring unit comprises a plurality of probes for detecting and measuring a video signal on the display characterization at a plurality of pixel locations.

11. The color uniformity characterizations system in accordance with claim 10, wherein the measuring unit further comprises a multiplexer for selecting the probes and a tri-stimulus detector for detecting tri-stimulus values of the video signal.

12. The color uniformity characterizations system in accordance with claim 8, wherein the measuring unit is a robot arm with a single probe that moves on the surface of the display under characterization for detecting and measuring the color values of the video signal at a plurality of pixel locations on the display device.

13. The color uniformity characterizations system in accordance with claim 8, wherein the color values and the calibration values are tri-stimulus values.

14. The color uniformity characterizations system in accordance with claim 8, wherein the processor unit comprises a microcontroller with embedded software.

15. The color uniformity characterizations system in accordance with claim 8, wherein the host computer is a stand along computer.

16. The color uniformity characterizations system in accordance with claim 8, wherein the host computer is a handheld device.

17. The color uniformity characterizations system in accordance with claim 16, wherein the processor unit is embedded in the handheld device.

18. A method of characterizing a display device comprising steps of: displaying a video signal comprising known color values for each pixel location on the display device covering a plurality of pixel locations; measuring the color values of pixel locations; calculating value differences between the video signal with known color value and the color value for each pixel location; and storing the value differences in a storage unit.

19. The method of characterizing a display device in accordance with claim 18, wherein the color values are tri-stimulus values.
